(19) United States
(12) Patent Application Publication
(10) Pub. No.: US 2010/0174038 A1
(43) Pub. Date: Jul. 8, 2010

(54) PROCESS FOR PRODUCING SOLID CATALYST COMPONENT PRECURSOR FOR OLEFIN POLYMERIZATION

(75) Inventors: Wataru HIRAHATA, Sodegaura-shi (JP); Shinya NAKAHARA, Ichihara-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/635,903

(22) Filed: Dec. 11, 2009

(30) Foreign Application Priority Data
Dec. 24, 2008 (JP) 2008-327873

(51) Int. Cl. C08F 4/16; B01J 23/00; B01J 23/02

(52) U.S. Cl. 526/127; 502/350; 502/340

(57) ABSTRACT

A production process is provided for an olefin polymerization catalyst component precursor, including the step of adding an organomagnesium compound to a solution containing a Si—O bond-containing silicon compound, a titanium compound represented by a defined formula, and a solvent, in an amount of 2.5 to 90 mol, per one liter of the solvent, of magnesium atoms contained in the organomagnesium compound added. Also provided are a production process of an olefin polymerization catalyst component using the above precursor; a production process of an olefin polymerization catalyst using the above catalyst component; and a production process of an olefin polymer using the above catalyst.

### BACKGROUND OF THE INVENTION

The present invention relates to a process for producing a solid catalyst component precursor for olefin polymerization; a process for producing an olefin polymerization solid catalyst component, using a solid catalyst component precursor produced according to the above production process; a process for producing an olefin polymerization solid catalyst, using an olefin polymerization solid catalyst component produced according to the above production process; and a process for producing an olefin polymer, using an olefin polymerization solid catalyst produced according to the above production process; those processes being suitable for a gas-phase polymerization process or a slurry polymerization process.

A large amount of olefin polymers adhering to a polymerization reactor is a source of troubles for operating a production process of olefin polymers. Therefore, it is desirable that an amount of olefin polymers adhering thereto is as small as possible. From such a viewpoint, it is preferable that olefin polymer powders obtained by olefin polymerization have an excellent particle property such as fluidity, from a viewpoint of stability and efficiency for operating a production process of olefin polymers.

U.S. Pat. No. 4,672,050 (corresponding to JP 61-218606A) discloses an α-olefin polymerization catalyst, which is high in its polymerization activity, hardly decreases stereoregularity during polymerization, and makes only a small amount of by-product amorphous polymer, and which catalyst is formed by a process comprising the steps of (i) contacting a solid catalyst component precursor with an ester compound, an ether compound and titanium tetrachloride, thereby obtaining a trivalent titanium compound-containing solid catalyst component, and (ii) contacting the obtained catalyst component with an organoaluminum compound and an electron donor compound (third component).

U.S. Pat. No. 6,187,883 (corresponding to JP 10-212312A) discloses an α-olefin polymerization catalyst, which is high in its polymerization activity, and makes only a very small amount of by-product amorphous polymer, and which catalyst is formed by a process comprising the steps of (i) reducing a titanium compound by an organomagnesium compound in the presence of a silicon compound and an ester compound, thereby obtaining a solid catalyst component precursor, (ii) contacting the obtained precursor with a halogenating compound, an electron donor and an organic acid halide, thereby obtaining a trivalent titanium compound-containing solid catalyst component, and (iii) contacting the obtained catalyst component with an organoaluminum compound and an electron donor compound (third component).

U.S. Pat. No. 6,903,041 (corresponding to JP 11-322833A) discloses an olefin polymerization catalyst, which is very excellent in its particle properties, is high enough in its polymerization activity, and makes only a small amount of low molecular weight polymer components, and which catalyst is formed by a process comprising the steps of (i) contacting a solid catalyst component precursor, a halogen-containing compound of Group 14 elements and an electron donor, with one another, then (ii) further contacting with titanium tetrachloride, thereby obtaining a solid catalyst component, and (iii) combining the obtained catalyst component with an organoaluminum compound.

### BRIEF SUMMARY OF THE INVENTION

However, olefin polymers obtained using the above respective olefin polymerization catalysts are unsatisfactory in their particle property.

In view of the above circumstances, the present invention has an object to provide (i) a process for producing a solid catalyst component precursor for olefin polymerization, (ii) a process for producing an olefin polymerization solid catalyst component, (iii) a process for producing an olefin polymerization solid catalyst, and (iv) a process for producing an olefin polymer; those processes being suitable for producing olefin polymers having an excellent particle property such as fluidity.

The present invention is a process for producing a solid catalyst component precursor for olefin polymerization, comprising the step of adding an organomagnesium compound to a solution containing a Si—O bond-containing silicon compound, a titanium compound represented by following formula [I], and a solvent, in an amount of 2.5 to 90 mol, per one liter of the solvent, of magnesium atoms contained in the organomagnesium compound added:

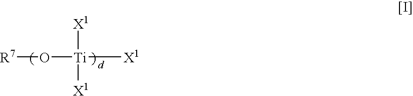

wherein R⁷ is a hydrocarbyl group having 1 to 20 carbon atoms; X¹ is a halogen atom or a hydrocarbyloxy group having 1 to 20 carbon atoms, and X¹s are the same as, or different from one another; and d is a number of 1 to 20, and preferably a number satisfying 1≦d≦5.

Also, the present invention is a process for producing an olefin polymerization solid catalyst component, comprising the step of contacting a solid catalyst component precursor for olefin polymerization produced according to the above production process with a halogenating metal compound represented by the following formula, an internal electron donor, and an optional organic acid halide:

M(R¹¹)ₑX³ₘ₋ₑ

wherein M is an element of Group 4, 13 or 14; R¹¹ is an alkyl or alkoxy group having 2 to 18 carbon atoms, or an aryl or aryloxy group having 6 to 18 carbon atoms; X³ is a halogen atom; m is an atomic valence of M; and e is a number satisfying 0<b≦m.

The above “halogenating metal compound” is a metal compound having a halogenating ability, which is a kind of halogenating agent.

Further, the present invention is a process for producing an olefin polymerization solid catalyst, comprising the step of contacting an olefin polymerization solid catalyst component produced according to the above production process with an organoaluminum compound, and an optional external electron donor.

Still further, the present invention is a process for producing an olefin polymer, comprising the step of polymerizing an olefin in the presence of an olefin polymerization solid catalyst produced according to the above production process.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a side view of a stainless-steel funnel 1 and its support 2, which was used for measuring a falling amount of polymer powders in Examples and Comparative Examples.

### DETAILED DESCRIPTION OF THE INVENTION

The solid catalyst component precursor for olefin polymerization in the present invention is obtained by reducing the titanium compound represented by formula [I] with an organomagnesium compound in the presence of a Si—O bond-containing silicon compound. A combination of the Si—O bond-containing silicon compound with an optionally-used ester compound may further improve a polymerization activity of an olefin polymerization solid catalyst obtained.

Examples of the Si—O bond-containing silicon compound are those represented by the following formulas:

Si(OR¹)ₐR²₄₋ₐ,

R³(R⁴₂SiO)_{b}SiR⁵₃, and

(R⁶₂SiO)_{c}

wherein R¹ is a hydrocarbyl group having 1 to 20 carbon atoms; R² to R⁶ are independently of one another a hydrocarbyl group having 1 to 20 carbon atoms, or a hydrogen atom; a is an integer of 1 to 4; b is an integer of 1 to 1,000; and c is an integer of 2 to 1,000.

Among them, preferred are alkoxysilanes represented by the above first formula, more preferred are tetraalkoxysilanes (a=4 in the above first formula), and most preferred is tetraethoxysilane.

Examples of the Si—O bond-containing silicon compound are tetramethoxysilane, dimethyldimethoxysilane, tetraethoxysilane, triethoxyethylsilane, diethoxydiethylsilane, ethoxytriethylsilane, tetraisopropoxysilane, diisopropoxydiisopropylsilane, tetrapropoxysilane, tetraisopropoxysilane, dipropoxydipropylsilane, tetra-n-butoxysilane, tetraisobutoxysilane, di-n-butoxydi-n-butylsilane, dicyclo-n-pentoxydiethylsilane, diethoxydiphenylsilane, cyclohexyloxytrimethylsilane, phenoxytrimethylsilane, tetraphenoxysilane, triethoxyphenylsilane, hexamethyldisiloxane, hexaethyldisiloxane, hexapropyldisiloxane, octaethyltrisiloxane, dimethylpolysiloxane, diphenylpolysiloxane, methylhydropolysiloxane and phenylhydropolysiloxane.

Examples of R⁷ in above formula [I] are alkyl groups such as a methyl group, an ethyl group, a propyl group, an isopropyl group, a n-butyl group, an isobutyl group, a n-pentyl group, an isoamyl group, a n-hexyl group, a heptyl group, an octyl group, a decyl group and a dodecyl group; aryl groups such as a phenyl group, a cresyl group, a xylyl group and a naphthyl group; cycloalkyl groups such as a cyclohexyl group and a cyclopentyl group; and an aralkyl group such as a benzyl group.

R⁷ is preferably alkyl groups having 2 to 18 carbon atoms, or aryl groups having 6 to 18 carbon atoms, and particularly preferably linear alkyl groups having 2 to 18 carbon atoms.

Examples of the halogen atom of X¹ in above formula [I] are a chlorine atom, a bromine atom and an iodine atom. Among them, a chlorine atom is particularly preferable.

The hydrocarbyloxy group having 1 to 20 carbon atoms of X¹ in above formula [I] are preferably linear alkoxy groups having 2 to 18 carbon atoms, more preferably linear alkoxy groups having 2 to 10 carbon atoms, and particularly preferably linear alkoxy groups having 2 to 6 carbon atoms.

Examples of the titanium compound represented by above formula [I] are tetramethoxytitanium, tetraethoxytitanium, tetra-n-propoxytitanium, tetraisopropoxytitanium, tetra-n-butoxytitanium, tetraisobutoxytitanium, n-butoxytitanium trichloride, di-n-butoxytitanium dichloride, tri-n-butoxytitanium chloride, di-n-tetraisopropylpolytitanate which is a mixture of compounds having “d” of 2 to 10 in above formula [I], tetra-n-butylpolytitanate which is a mixture of compounds having “d” of 2 to 10 in above formula [I], tetra-n-hexylpolytitanate which is a mixture of compounds having “d” of 2 to 10 in above formula [I], tetra-n-octylpolytitanate which is a mixture of compounds having “d” of 2 to 10 in above formula [I], a condensate obtained by reacting a tetraalkoxytitanium with a small amount of water, and a combination of two or more of those compounds.

The titanium compound represented by above formula [I] is preferably those having “d” of 1, 2 or 4 therein, and more preferably tetra-n-butoxytitanium, tetra-n-butyltitanium dimer, or tetra-n-butyltitanium tetramer.

The above organomagnesium compound is any compounds containing a magnesium-carbon bond (Mg—C bond) therein. Examples thereof are those represented by the following formulas:

R⁸MgX², and

R⁹R¹⁰Mg

wherein R⁸ to R¹⁰ are a hydrocarbyl group having 1 to 20 carbon atoms; and X² is a halogen atom.

Examples of R⁸ to R¹⁰ are alkyl groups, aryl groups, aralkyl groups and alkenyl groups, those groups having 1 to 20 carbon atoms, respectively, such as a methyl group, an ethyl group, a propyl group, an isopropyl group, a butyl group, a sec-butyl group, a tert-butyl group, an isoamyl group, a hexyl group, an octyl group, a 2-ethylhexyl group, a phenyl group and a benzyl group.

Examples of X² in the above formula are a chlorine atom, a bromine atom and an iodine atom. Among them, a chlorine atom is particularly preferable.

Examples of the Grignard compound represented by the above former formula are methylmagnesium chloride, ethylmagnesium chloride, n-propylmagnesium chloride, isopropylmagnesium chloride, n-butylmagnesium chloride, isobutylbutylmagnesium chloride, tert-butylmagnesium chloride, n-pentylmagnesium chloride, isoamylmagnesium chloride, cyclopentylmagnesium chloride, n-hexylmagnesium chloride, cyclohexylmagnesium chloride, n-octylmagnesium chloride, 2-ethylhexylmagnesium chloride, phenylmagnesium chloride, and benzylmagnesium chloride. Among them, preferred is ethylmagnesium chloride, n-propylmagnesium chloride, isopropylmagnesium chloride, n-butylmagnesium chloride, or isobutylbutylmagnesium chloride, and particularly preferred is n-butylmagnesium chloride, in order to obtain good shape-carrying polymerization catalysts.

Those Grignard compounds are used preferably as an ether solution thereof. Examples of the ether are dialkyl ethers such as diethyl ether, di-n-propyl ether, diisopropyl ether, di-n-butyl ether, diisobutyl ether, ethyl n-butyl ether, and diisoamyl ether; and cyclic ethers such as tetrahydrofuran. Among them, preferred are dialkyl ethers, and particularly preferred is di-n-butyl ether or diisobutyl ether.

Examples the above ester compound are monocarboxylic acid esters and polycarboxylic acid esters. More specific examples thereof are saturated aliphatic carboxylic acid esters, unsaturated aliphatic carboxylic acid esters, alicyclic carboxylic acid esters, and aromatic carboxylic acid esters. Further specific examples thereof are methyl acetate, ethyl acetate, phenyl acetate, methyl propionate, ethyl propionate, ethyl butyrate, ethyl valerate, ethyl acrylate, methyl methacrylate, ethyl benzoate, n-butyl benzoate, isobutyl benzoate, methyl toluate, ethyl toluate, ethyl anisate, diethyl succinate, di-n-butyl succinate, diisobutyl succinate, diethyl malonate, dibutyl malonate, diisobutyl malonate, dimethyl maleate, di-n-butyl maleate, diisobutyl maleate, diethyl itaconate, di-n-butyl itaconate, diisobutyl itaconate, monoethyl phthalate, dimethyl phthalate, methyl ethyl phthalate, diethyl phthalate, di-n-propyl phthalate, diisopropyl phthalate, di-n-butyl phthalate, diisobutyl phthalate, dipentyl phthalate, di-n-hexyl phthalate, diheptyl phthalate, di-n-octyl phthalate, di(2-ethylhexyl) phthalate, diisodecyl phthalate, dicyclohexyl phthalate and diphenyl phthalate. Among them, preferred are unsaturated aliphatic carboxylic acid esters such as methacrylic acid esters and maleic acid esters, or aromatic carboxylic acid esters such as benzoic acid esters and phthalic acid esters, and particularly preferred are dialkyl phthalates.

When the organomagnesium compound is added to a solution containing the Si—O bond-containing silicon compound, the titanium compound represented by formula [I], a solvent, and an optional ester compound, four-valent titanium atoms contained in the titanium compound are reduced by the organomagnesium compound to three-valent titanium atoms. It is preferable in the present invention that substantially all of four-valent titanium atoms are reduced to three-valent titanium atoms.

Examples of the solvent are aliphatic hydrocarbons such as hexane, heptane, octane and decane; aromatic hydrocarbons such as toluene and xylene; alicyclic hydrocarbons such as cyclohexane, methylcyclohexane and decalin; dialkyl ethers such as diethyl ether, di-n-propyl ether, diisopropyl ether, di-n-butyl ether, diisobutyl ether, ethyl n-butyl ether, and diisoamyl ether; cyclic ether such as tetrahydrofuran; and combinations of two of more thereof. Among them, preferred are aliphatic hydrocarbons, aromatic hydrocarbons or alicyclic hydrocarbons, more preferred are aliphatic hydrocarbons or alicyclic hydrocarbons, further preferred are aliphatic hydrocarbons, and particularly preferred is hexane or heptane.

In order to obtain olefin polymer powders having an excellent particle property such as fluidity, the organomagnesium compound is used in an amount such that the total amount of magnesium atoms contained in the organomagnesium compound used is 2.5 to 90 mol, preferably 3.0 to 80 mol, more preferably 3.5 to 70 mol, further preferably 4.0 to 60 mol, and particularly preferably 4.5 to 50 mol, per one liter of the solvent used.

The above reduction reaction is carried out at usually −50 to 100° C., preferably −30 to 70° C., and further preferably −25 to 50° C. Its reaction time is not particularly limited, and is usually 30 minutes to 6 hours. In order to promote the reduction reaction, the reaction may be further continued at 5 to 120° C.

The silicon compound is used in an amount of usually 1 to 500 mol, preferably 1 to 300 mol, and particularly preferably 3 to 100 mol, in terms of the total amount of silicon atoms contained in the silicon compound used, per one mol of titanium atoms contained in the titanium compound used.

The organomagnesium compound is used in an amount such that the total amount of the above titanium atoms and silicon atoms is usually 0.1 to 10 mol, preferably 0.2 to 5.0 mol, and particularly preferably 0.5 to 2.0 mol, per one mol of magnesium atoms contained in the organomagnesium compound used.

Also, each of the titanium compound, the silicon compound and the organomagnesium compound may be determined in its used amount such that an amount of magnesium atoms contained in the obtained solid catalyst component precursor is 1 to 51 mol, preferably 2 to 31 mol, and particularly preferably 4 to 26, per one mol of titanium atoms contained in the solid catalyst component precursor.

The ester compound is used in an amount of usually 0.05 to 100 mol, preferably 0.1 to 60 mol, and particularly preferably 0.2 to 30 mol, per one mol of titanium atoms contained in the titanium compound used.

The obtained solid catalyst component precursor may be washed with a solvent to be purified. Examples of the solvent are aliphatic hydrocarbons such as pentane, hexane, heptane, octane and decane; aromatic hydrocarbons such as benzene, toluene, ethylbenzene, and xylene; alicyclic hydrocarbons such as cyclohexane and cyclopentane; and halogenated hydrocarbons such as 1,2-dichloroethane and monochlorobenzene. Among them, preferred are aliphatic hydrocarbons or aromatic hydrocarbons, more preferred are aromatic hydrocarbons, and further preferred is toluene or xylene.

The obtained solid catalyst component precursor contains trivalent titanium atoms, magnesium atoms and hydrocarbyloxy groups, and generally has an amorphous structure or a very weak crystalline structure. Among them, the amorphous structure is preferable in the present invention.

The above step of contacting the solid catalyst component precursor with the halogenating metal compound, the internal electron donor, and the optional organic acid halide is generally referred to as an activation step, thereby obtaining a solid catalyst component.

Examples of the element of Group 4 of M in the above formula representing the halogenating metal compound are titanium, zirconium and hafnium. Among them, preferred is titanium. Examples of the element of Group 13 of M therein are boron, aluminum, gallium, indium, and thallium. Among them, preferred is boron or aluminum, and more preferred is aluminum. Examples of the element of Group 14 of M therein are silicon, germanium, tin, and lead. Among them, preferred is silicon, germanium or tin, and more preferred is silicon. M is particularly preferably titanium or silicon.

Examples of R¹¹ in the above formula are linear or branched alkyl groups such as a methyl group, an ethyl group, a n-propyl group, an isopropyl group, a n-butyl group, an isobutyl group, a tert-butyl group, a n-pentyl group, an isoamyl group, a n-hexyl group, a n-heptyl group, a n-octyl group, a n-decyl group and a n-dodecyl group; cycloalkyl groups such as a cyclopentyl group and a cyclohexyl group; aryl groups such as a pheny group, a cresyl group, a xylyl group, and a naphthyl group; linear or branched alkoxy groups such as a methoxy group, an ethoxy group, a n-propoxy group, an isopropoxy group, a n-butoxy group, an isobutoxy group, a n-pentyloxy group, an isoamyloxy group, a n-hexyloxy group, a n-heptyloxy group, a n-octyloxy group, a n-decyloxy group and a n-dodecyloxy group; cycloalkoxy groups such as a cyclopentyloxy group and a cyclohexyloxy group; and aryloxy groups such as a phenoxy group, a xyloxy group, and a naphthoxy group. Among them, preferred are alkyl or alkoxy groups having 2 to 18 carbon atoms, or aryl or aryloxy groups having 6 to 18 carbon atoms.

In the above formula, m is a valence of M. When M is an element of Group 4, m is 4, when M is an element of Group 13, m is 3, and when M is an element of Group 14, m is 4. Also, e is a number satisfying 0<e≦m. When M is an element of Group 4 or 14, e is a number satisfying 0<e≦4, and when M is an element of Group 13, e is a number satisfying 0<e≦3. When M is an element of Group 4 or 14, e is preferably 3 or 4, and more preferably 4. When M is an element of Group 13, e is preferably 3.

Examples of the halogenating metal compound represented by the above formula are titanium compounds disclosed in U.S. Pat. No. 6,187,883 mentioned above, and chlorinating compounds of elements of Group 13 or 14 disclosed in U.S. Pat. No. 6,903,041 mentioned above.

Halogenating titanium compounds of the halogenating metal compound represented by the above formula are preferably titanium tetrahalides such as titanium tetrachloride, titanium tetrabromide, and titanium tetraiodide, or alkoxytitanium trihalides such as methoxytitanium trichloride, ethoxytitanium trichloride, n-butoxytitanium trichloride, isobutoxytitanium trichloride, phenoxytitanium trichloride, and ethoxytitanium tribromide; more preferably titanium tetrahalides; and particularly preferably titanium tetrachloride.

The above chlorinating compounds of elements of Group 13 or 14 of the halogenating metal compound represented by the above formula are preferably ethylaluminum dichloride, ethylaluminum sesquichloride, diethylaluminum chloride, trichloaluminum, tetrachlorosilane, phenyltrichlorosilane, methyltrichlorosilane, ethyltrichlorosilane, n-propyltrichlorosilane, or p-tolyltrichlorosilane; more preferably chlorinating compounds of elements of Group 14; and particularly preferably tetrachlorosilane or phenyltrichlorosilane.

The halogenating metal compound is used in an amount of usually 0.1 to 1.000 mmol, preferably 0.3 to 500 mmol, and particularly preferably 0.5 to 300 mmol, per one gram of the solid catalyst component precursor. The halogenating metal compound is used at one time, or in two or more batches.

Examples of the above internal electron donor are oxygen-containing electron donors such as alcohols, phenols, ketones, aldehydes, carboxylic acids, esters of organic or inorganic acids, ethers, acid amides, and acid anhydrides; and nitrogen-containing electron donors such as ammonia, amines, nitriles, and isocyanates. Among them, preferred are esters of organic acids or ethers. Examples of the esters of organic acids are ester compounds exemplified above. Examples of the ethers are those disclosed in U.S. Pat. No. 6,903,041 mentioned above. Among them, preferred are dialkyl ethers, and particularly preferred is dibutyl ether or diisoamyl ether. The internal electron donor is preferably esters of organic acids, particularly preferably dialkyl esters of aromatic dicarboxylic acids, and most preferably dialkyl phthalates.

The internal electron donor is used in an amount of usually 0.1 to 1.000 mmol, preferably 0.3 to 500 mmol, and particularly preferably 0.5 to 300 mmol, per one gram of the solid catalyst component precursor. The internal electron donor is used at one time, or in two or more batches.

Examples of the above organic acid halide are monocarboxylic acid halides and polycarboxylic acid halides. More specific examples thereof are aliphatic carboxylic acid halides, alicyclic carboxylic acid halides, and aromatic carboxylic acid halides. Further specific examples thereof are acetyl chloride, propanoyl chloride, butanoyl chloride, valeroyl chloride, acryloyl chloride, methacryloyl chloride, benzoyl chloride, toluoyl chloride, anisoyl chloride, succinoyl chloride, malonyl chloride, malenyl chloride, itaconoyl chloride, and phthaloyl chloride. Among them, preferred are aromatic carboxylic acid chlorides such as benzoyl chloride, toluoyl chloride and phthaloyl chloride, and particularly preferred is phthaloyl chloride.

The organic acid halide is used in an amount of usually 0.1 to 50 mol, further preferably 0.3 to 20 mol, and particularly preferably 0.5 to 10 mol, per one mol of titanium atoms contained in the solid catalyst component precursor. When the amount exceeds 50 mol, the obtained solid catalyst component particles may be broken.

The solid catalyst component precursor, the halogenating metal compound, the internal electron donor and the organic acid halide are not particularly limited in a method of contacting them with one another. Examples of the method are those known in the art such as a slurry method and a mechanically-crushing method (for example, ball mill crushing method). The mechanically-crushing method is carried out preferably in the presence of a dilution agent, in order to control an amount of fine powders contained in the solid catalyst component obtained, and also in order to control broadening of a particle size distribution of the solid catalyst component obtained.

Examples of the dilution agent are aliphatic hydrocarbons such as pentane, hexane, heptane and octane; aromatic hydrocarbons such as benzene, toluene and xylene; alicyclic hydrocarbons such as cyclohexane and cyclopentane; and halogenated hydrocarbons such as 1,2-dichloroethane and monochlorobenzene. Among them, particularly preferred are aromatic hydrocarbons or halogenated hydrocarbons.

The above slurry method has a slurry concentration of usually 0.05 to 0.7 g-solid/ml-solvent, and particularly preferably 0.1 to 0.5 g-solid/ml-solvent. The above contact is carried out usually at 30 to 150° C., preferably at 45 to 135° C., and particularly preferably at 60 to 120° C. The contact time is not particularly limited, and is preferably 30 minutes to about 6 hours usually.

Examples of the organoaluminum compound used in the present invention are those disclosed in U.S. Pat. No. 6,903,041 mentioned above. Among them, preferred are trialkylaluminums, mixtures of trialkylaluminums with dialkylaluminum halides, or alkylalumoxanes; and further preferred is triethylaluminum, triisobutylaluminum, a mixture of triethylaluminum with diethylaluminum chloride, or tetraethyldialumoxane.

Examples of the external electron donor optionally used in the present invention are those disclosed in U.S. Pat. No. 6,187,883 mentioned above. Among them, preferred are oxygen-containing compounds or nitrogen-containing compounds. Examples of the oxygen-containing compounds are alkoxysilicons, ethers, esters and ketones. Among them, preferred are alkoxysilicons or ethers.

The above alkoxysilicons are preferably compounds represented by the following formula:

R¹²_{f}Si(OR¹³)_{4-f}

wherein R¹² is a hydrocarbyl group having 1 to 20 carbon atoms, a hydrogen atom, or a hetero atom-containing group; R¹³ is a hydrocarbyl group having 1 to 20 carbon atoms; f is a number satisfying 0≦f<4; and when plural R¹²s or R¹³s exist, they are the same as, or different from one another, respectively.

The above ethers as the external electron donor are more preferably cyclic ethers. The cyclic ethers are heterocyclic compounds having one or more ether bonds (—C—O—C—) in their rings, and are more preferably cyclic ethers having one or more diether bonds (—C—O—C—O—C—) in their rings.

The external electron donor is particularly preferably cyclohexylmethyldimethoxysilane, cyclohexylethyldimethoxysilane, diisopropyldimethoxysilane, tert-butylethyldimethoxysilane, tert-butyl-n-propyldimethoxysilane, phenyltrimethoxysilane, diphenyldimethoxysilane, dicyclobutyldimethoxysilane, dicyclopentyldimethoxysilane, 1,3-dioxolane, or 1,3-dioxane.

The solid catalyst component, the organoaluminum compound and the optionally-used external electron donor are not particularly limited in a method of contacting those components with one another, as long as a solid catalyst for olefin polymerization is formed. Their contact is carried out in the presence of a solvent, or in the absence thereof. Examples of the method of contacting those components are (i) a method comprising the steps of contacting all of those components, thereby forming a contact product (i.e., polymerization catalyst), and then supplying the contact product to a polymerization reactor, (ii) a method comprising the step of supplying those components separately to a polymerization reactor, thereby contacting those components with one another in the polymerization reactor to form a polymerization catalyst, and (iii) a method comprising the steps of contacting any two of those components with each other, thereby forming a contact product, and then supplying the contact product and the remaining one component separately to a polymerization reactor, thereby contacting them with each other in the polymerization reactor to form a polymerization catalyst. The above supply to a polymerization reactor is carried out preferably in an atmosphere of an inert gas such as nitrogen and argon, and in a water-free state.

Examples of the olefin used in the polyolefin production process of the present invention are ethylene and α-olefins having three or more carbon atoms. Examples of those α-olefins are linear mono-olefins such as propylene, 1-butene, 1-pentene, 1-hexene, 1-heptene, 1-octene and 1-decene; branched mono-olefins such as 3-methyl-1-butene, 3-methyl-1-pentene and 4-methyl-1-pentene; and cyclic mono-olefins such as vinylcyclohexane; and combinations of two or more of those olefins. Among them, preferred are homopolymers of ethylene, homopolymers of propylene, or copolymers of combinations of two or more kinds of olefins, those combinations containing ethylene or propylene as a major monomer. The above combinations of two or more kinds of olefins may contain combinations of two or more kinds of α-olefins except propylene, and may contain two or more unsaturated bond-carrying monomers such as conjugated dienes and non-conjugated dienes.

Olefin polymers produced according to the polyolefin production process of the present invention are preferably homopolymers of ethylene, homopolymers of propylene, homopolymers of 1-butene, homopolymers of 1-pentene, homopolymers of 1-hexene, ethylene-propylene copolymers, ethylene-1-butene copolymers, ethylene-1-hexene copolymers, propylene-1-butene copolymers, propylene-1-hexene copolymers, ethylene-propylene-1-butene copolymers, ethylene-propylene-1-hexene copolymers, or block copolymers produced by multistep polymerization of those olefins.

In order to produce olefin polymers having a good powder property, the olefin polymerization solid catalyst component used in the process for producing an olefin polymerization solid catalyst of the present invention is preferably a pre-polymerized solid catalyst component, as produced below. The pre-polymerized solid catalyst component can be produced by polymerizing a small amount of an olefin in the presence of the above-mentioned olefin polymerization solid catalyst component and organoaluminum compound, wherein (i) the olefin is the same as, or different from an olefin used in the production process of olefin polymers of the present invention in its type, and (ii) a chain-transfer agent such as hydrogen, or the above-mentioned external electron donor may be used. The above polymerization for producing the pre-polymerized solid catalyst component is generally referred to as a “pre-polymerization” in contrast to the “main polymerization” in the production process of olefin polymers of the present invention. The pre-polymerized solid catalyst component is, in other words, a modified solid catalyst component, whose surface is covered by the resultant polymer. Such pre-polymerization is disclosed in U.S. Pat. Nos. 6,187,883 and 6,903,041, both mentioned above.

Therefore, a process for producing an olefin polymerization solid catalyst using a pre-polymerized solid catalyst component comprises the following steps (1) and (2) before the contacting step in the process for producing an olefin polymerization solid catalyst of the present invention:

(1) contacting an olefin polymerization solid catalyst component with an organoaluminum compound, thereby forming a contact product; and

(2) polymerizing an olefin in the presence of the contact product, thereby forming a pre-polymerized solid catalyst component.

So formed pre-polymerized solid catalyst component is used in the contacting step as the olefin polymerization solid catalyst component.

The above pre-polymerization is preferably a slurry polymerization in an inert hydrocarbon solvent such as propane, butane, isobutane, pentane, isopentane, hexane, heptane, octane, cyclohexane, benzene and toluene.

The organoaluminum compound in the pre-polymerization is used in an amount of generally 0.5 to 700 mol, preferably 0.8 to 500 mol, and particularly preferably 1 to 200 mol, per one mol of titanium atoms contained in the solid catalyst component used in the pre-polymerization.

The olefin in the pre-polymerization is pre-polymerized in an amount of generally 0.01 to 1,000 g, preferably 0.05 to 500 g, and particularly preferably 0.1 to 200 g, per one gram of the solid catalyst component used in the pre-polymerization.

The pre-polymerization is preferably a slurry polymerization, and the slurry concentration of the solid catalyst component is preferably 1 to 500 g-solid catalyst component/liter-solvent, and particularly preferably 3 to 300 g-solid catalyst component/liter-solvent.

The pre-polymerization is carried out at preferably −20 to 100° C., and particularly preferably 0 to 80° C., and under a partial pressure of an olefin in a gas phase of preferably 0.01 to 2 MPa, and particularly preferably 0.1 to 1 MPa, provided that an olefin in a liquid state under a pre-polymerization temperature and a pre-polymerization pressure is not limited thereto. A pre-polymerization time is not particularly limited, and is preferably 2 minutes to 15 hours.

The solid catalyst component, organoaluminum compound and olefin are supplied to a pre-polymerization reactor according to the below-exemplified method (i) or (ii):

(i) a method comprising the steps of feeding the solid catalyst component and the organoaluminum compound, and then feeding the olefin; or

(ii) a method comprising the steps of feeding the solid catalyst component and the olefin, and then feeding the organoaluminum compound.

The olefin in the pre-polymerization is supplied to a pre-polymerization reactor according to the below-exemplified method (i) or (ii):

(i) a method of sequentially feeding the olefin to the pre-polymerization reactor, so as to keep an inner pressure of the pre-polymerization reactor at a predetermined level; or

(ii) a method of feeding a predetermined total amount of the olefin at the same time to the pre-polymerization reactor.

The external electron donor is optionally used in the pre-polymerization in an amount of generally 0.01 to 400 mol, preferably 0.02 to 200 mol, and particularly preferably 0.03 to 100 mol, per one mol of titanium atoms containing in the solid catalyst component used in the pre-polymerization, and is optionally used in an amount of generally 0.003 to 5 mol, preferably 0.005 to 3 mol, and particularly preferably 0.01 to 2 mol, per one mol of the organoaluminum compound used in the pre-polymerization.

The external electron donor in the pre-polymerization is supplied to a pre-polymerization reactor according to the below-exemplified method (i) or (ii):

(i) a method of feeding independently the external electron donor to a pre-polymerization reactor; or

(ii) a method of feeding a contact product of the external electron donor with the organoaluminum compound to a pre-polymerization reactor.

The organoaluminum compound in the main polymerization is used in an amount of usually 1 to 10,000 mol, and particularly preferably 5 to 6,000 mol, per one mol of titanium atoms contained in the solid catalyst component used in the main polymerization.

The external electron donor in the main polymerization is used in an amount of usually 0.1 to 2,000 mol, preferably 0.3 to 1,000 mol, and particularly preferably 0.5 to 800 mol, per one mol of titanium atoms contained in the solid catalyst component used in the main polymerization, or is used in an amount of usually 0.001 to 5 mol, preferably 0.005 to 3 mol, and particularly preferably 0.01 to 1 mol, per one mol of the organoaluminum compound used in the main polymerization.

The main polymerization is carried out (1) at usually −30 to 300° C., and preferably 20 to 180° C., (2) under a pressure, which is not particularly limited, of usually an atmospheric pressure to 10 MPa, and preferably 200 kPa to 5 MPa, from an industrial and economical point of view, (3) according to a batchwise method or a continuous method, and (4) according to (i) a slurry or solution polymerization method with inert hydrocarbon solvents such as propane, butane, isobutane, pentane, hexane, heptane and octane, (ii) a bulk polymerization method using an olefin as a solvent, which olefin is liquid at a polymerization temperature, or (iii) a gas-phase polymerization method.

In order to control a molecular weight of olefin polymers obtained in the main polymerization, there may be used a chain transfer agent such as hydrogen and alkyl zincs (for example, dimethyl zinc and diethyl zinc).

According to the present invention, there can be obtained (i) olefin polymers having an excellent particle property such as fluidity, (ii) solid catalyst component precursors for olefin polymerization, (iii) olefin polymerization solid catalyst components, and (iv) olefin polymerization solid catalysts.

### EXAMPLE

The present invention is explained in more detail with reference to the following Examples, which do not limit the present invention.

### Example 1

### (1) Preparation of Solid Catalyst Component Precursor for Olefin Polymerization

A 500 ml-inner volume separable flask equipped with an agitator was purged with a nitrogen gas. There were put in the flask 94 ml of hexane (solvent), 8.9 ml (25 mmol) of tetra-n-butoxytitanium (titanium compound), and 88.2 ml (395 mmol) of tetraethoxysilane (silicon compound). While agitating the resultant mixture, and keeping an inner temperature of the flask at 10° C., 204 ml (428 mmol) of a di-n-butyl ether solution (concentration: 2.1 mol/liter) of n-butylmagnesium chloride (organomagnesium compound) was added dropwise to the mixture over 4 hours at a constant dropping rate. The total amount of magnesium atoms contained in the organomagnesium compound used was 4.6 mol per one liter of the solvent. After completion of the dropwise addition, the obtained mixture was agitated to 20° C. for one hour. Then, the reaction mixture was filtered, and the obtained solid was washed with each 280 ml of toluene three times, thereby obtaining a solid catalyst component precursor having an excellent particle shape. There was added 160 ml of toluene to the solid catalyst component precursor, thereby obtaining a toluene slurry of the solid catalyst component precursor, which slurry was found to have a concentration of 0.19 g-precursor/ml-slurry.

The above solid catalyst component precursor was found to contain 1.68% by weight of titanium atoms, 38.1% by weight of ethoxy groups, and 4.07% by weight of butoxy groups.

### (2) Preparation of Solid Catalyst Component for Olefin Polymerization

A 100 ml flask equipped with an agitator, a dropping funnel and a thermometer was purged with a nitrogen gas. The above slurry was added to the flask in an amount such that 7.00 g of the solid catalyst component precursor was added thereto. Then, 3.1 ml of toluene, 5.1 ml (32 mmol) of phenyltrichlorosilane (halogenating metal compound) and 5.4 ml (74 mmol) of di(2-ethylhexeyl)phthalate (internal electron donor) were added to the flask. The resultant mixture was agitated at 105° C. for 2 hours. The obtained mixture was solid-liquid separated, and the separated solid was washed at 100° C. with each 35 ml of toluene three times, thereby obtaining a washed solid. The washed solid was combined with 10 ml of toluene, and 3.5 ml (32 mmol) of titanium tetrachloride (halogenating metal compound) was added thereto, and the resultant mixture was agitated at 105° C. for 2 hours. The mixture was solid-liquid separated. The obtained solid was washed at 100° C. with each 35 ml of toluene six times, and was further washed at a room temperature with each 35 ml of hexane two times. The washed solid was dried under reduced pressure, thereby obtaining 7.15 g of a solid catalyst component having an excellent particle shape.

The solid catalyst component was found to contain 0.66% by weight of titanium atoms, and was found to have a median particle diameter of 39 μm.

### (3) Preparation of Ethylene-1-Butene Copolymer

A 3 liter-inner volume autoclave equipped with an agitator was dried sufficiently, and was made vacuum. There were put therein 0.087 MPa of hydrogen, 640 g of butane and 110 g of 1-butene (olefin), and the autoclave was heated up to 70° C. Ethylene (olefin) was added thereto till its partial pressure reached 0.6 MPa. There were pressed into the autoclave 17.6 mg of the solid catalyst component obtained in Example 1(2) and 5.7 mmol of triethylaluminum (organoaluminum compound) with argon gas, thereby initiating a polymerization reaction. While feeding ethylene continuously into the autoclave, and keeping its total pressure constant, the polymerization reaction was carried out at 70° C. for 3 hours. After completion of the polymerization reaction, the unreacted monomers were purged, thereby obtaining 142 g of an ethylene-1-butene powdery copolymer excellent in its particle property.

A yield of the copolymer per one g of the solid catalyst component was 8,050 g-copolymer/g-solid catalyst component (polymerization activity). The copolymer was found to have a short-chain branch number (SCB) of 11.3; 1.4% by weight of soluble parts in xylene (CXS), the total weight of the copolymer being 100% by weight; a bulk density of 0.355 g/ml; a melt flow rate (MFR) of 0.15; a melt flow rate ratio (MFRR) of 29.9; and a falling amount of 392 ml/sec.

Results are shown in Table 1.

The above particle shape was observed with a digital microscope (VH-6200) and a scanning electron microscope (VE-8800), manufactured by Keyence Corporation.

The above titanium atom content (% by weight) was measured according to a method comprising the steps of:

(i) decomposing about 20 mg of a sample with about 30 ml of 2 normal (2N) dilute sulfuric acid;

(ii) adding 3 ml (excess amount) of hydrogen peroxide water having a concentration of 3% by weight thereto, thereby preparing a liquid sample;

(iii) measuring a characteristic absorption of the liquid sample at 410 nm with a double-beam spectrophotometer, U-2001, manufactured by Hitachi, Ltd.; and

(iv) obtaining an amount of titanium atoms using a separately-prepared calibration curve.

The above alkoxy group content (% by weight) was measured according to a method comprising the steps of:

(1) decomposing about 2 g of a sample with 100 mL of water to obtain a liquid sample;

(2) measuring an amount of an alcohol (corresponding to an alkoxy group) contained in the liquid sample according to a gas chromatography internal standard method; and

(3) converting the obtained amount of an alcohol to an alkoxy group content.

The above median particle diameter (μm) was measured with a laser diffraction-style apparatus for measuring a particle size distribution (SALD-2100) manufacture by Shimadzu Corporation.

The above SCB, which means the number of methyl groups per 1,000 carbon atoms, was obtained from characteristic absorptions of ethylene units and α-olefin units (1-butene units) assigned in an infrared absorption spectrum measured with an infrared spectrophotometer, FT/IR-470 PLUS, manufactured by Japan Spectroscopic Co., Ltd., using a calibration curve.

The above CXS (% by weight), which means an amount of soluble parts in xylene at 20° C., was measured according to a method comprising the steps of:

(i) adding 1 g of a copolymer to 200 ml of boiling xylene, thereby obtaining a solution;

(ii) cooling the solution slowly down to 50° C.;

(iii) further cooling the solution down to 20° C. by dipping it in an iced water bath under agitation;

(iv) keeping the solution at 20° C. for 3 hours, thereby precipitating a copolymer;

(v) filtering off the precipitated copolymer, thereby obtaining a filtrate;

(vi) distilling xylene contained in the filtrate away to dryness, thereby obtaining soluble parts;

(vii) weighing the soluble parts; and

(viii) calculating CXS based thereon.

The above bulk density (g/ml) was measure according to JIS K6721 (1966), “JIS” being Japanese Industrial Standards.

The above MFR means a flow rate of a polymer in a molten state, and was measured at 190° C. under a load according to ASTM D1238, and the above MFRR means a ratio of an MFR measured under a load of 21.60 kg to an MFR measured under a load of 2.16 kg. In general, the wider a molecular weight distribution of a polymer is, the larger its MFRR is.

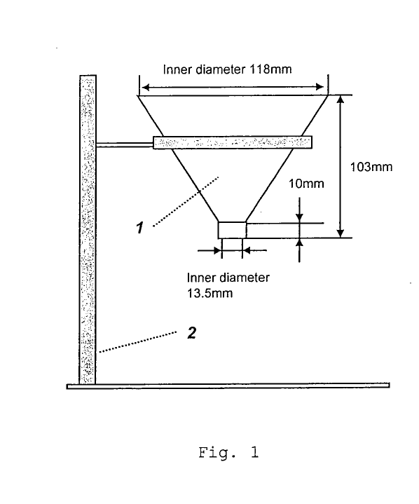

The above falling amount (ml/second) was measured with the stainless-steel funnel shown in FIG. 1, according to a method comprising the steps of:

(i) pouring a powdery polymer into the funnel from its upper part, thereby flowing the polymer down at a constant flow rate;

(ii) measuring an amount of the polymer flowing for five seconds, W (gram/5 seconds);

(iii) calculating an amount of the polymer flowing for ten seconds, 2×W (gram/10 seconds);

(iv) calculating 2×W÷BD, thereby obtaining a volume of the polymer flowing for ten seconds, V (ml/10 seconds), BD being a bulk density (g/ml) of the polymer; and

(v) calculating V÷10, thereby obtaining a falling amount (ml/second);

wherein the larger the falling amount is, the better the polymer's fluidity is.

### Example 2

### (1) Preparation of Solid Catalyst Component Precursor for Olefin Polymerization

Example 1(1) was repeated except that (i) the amount of hexane (94 ml) was changed to 70 ml, (ii) the inner temperature of the flask (10° C.) was changed to 20° C., and (iii) the amount of toluene (160 ml) added to the solid catalyst component precursor was changed to 150 ml, wherein the total amount of magnesium atoms contained in the organomagnesium compound used was 6.1 mol per one liter of the solvent, thereby obtaining a toluene slurry of the solid catalyst component precursor having an excellent particle shape, which slurry was found to have a concentration of 0.20 g-precursor/ml-slurry.

The solid catalyst component precursor was found to contain 1.83% by weight of titanium atoms, 39.8% by weight of ethoxy groups, and 3.95% by weight of butoxy groups.

### (2) Preparation of Solid Catalyst Component for Olefin Polymerization

Example 1(2) was repeated except that (i) the slurry was changed to the slurry obtained in Example 2(1), which was added to the flask in an amount such that 7.00 g of the solid catalyst component precursor was added thereto, and (ii) the added amount of toluene (1.6 ml) was changed to 6.2 ml, thereby obtaining 7.08 g of a solid catalyst component having an excellent particle shape.

The solid catalyst component was found to contain 0.70% by weight of titanium atoms, and was found to have a median particle diameter of 33 μm.

### (3) Preparation of Ethylene-1-Butene Copolymer

Example 1(3) was repeated except that 17.6 mg of the solid catalyst component was changed to 22.5 mg of the solid catalyst component obtained in Example 2(2), thereby obtaining 154 g of an ethylene-1-butene powdery copolymer excellent in its particle property.

A yield of the copolymer per one g of the solid catalyst component was 6,850 g-copolymer/g-solid catalyst component (polymerization activity). The copolymer was found to have a short-chain branch number (SCB) of 17.8; 4.4% by weight of soluble parts in xylene (CXS), the total weight of the copolymer being 100% by weight; a bulk density of 0.372 g/ml; a melt flow rate (MFR) of 0.53; a melt flow rate ratio (MFRR) of 24.6; and a falling amount of 419 ml/sec.

Results are shown in Table 1.

### Example 3

### (1) Preparation of Solid Catalyst Component Precursor for Olefin Polymerization

Example 1(1) was repeated except that (i) the amount of hexane (94 ml) was changed to 47 ml, (ii) the inner temperature of the flask (10° C.) was changed to 20° C., and (iii) the amount of toluene (160 ml) added to the solid catalyst component precursor was changed to 180 ml, wherein the total amount of magnesium atoms contained in the organomagnesium compound used was 9.1 mol per one liter of the solvent, thereby obtaining a toluene slurry of the solid catalyst component precursor having an excellent particle shape, which slurry was found to have a concentration of 0.15 g-precursor/ml-slurry.

The solid catalyst component precursor was found to contain 1.49% by weight of titanium atoms, 37.7% by weight of ethoxy groups, and 3.86% by weight of butoxy groups.

### (2) Preparation of Solid Catalyst Component for Olefin Polymerization

Example 1(2) was repeated except that (i) the slurry was changed to the slurry obtained in Example 3(1), which was added to the flask in an amount such that 7.00 g of the solid catalyst component precursor was added thereto, and (ii) 6.6 ml of toluene was removed with a syringe, thereby obtaining 7.21 g of a solid catalyst component having an excellent particle shape.

The solid catalyst component was found to contain 0.61% by weight of titanium atoms, and was found to have a median particle diameter of 38 μm.

### (3) Preparation of Ethylene-1-Butene Copolymer

Example 1(3) was repeated except that 17.6 mg of the solid catalyst component was changed to 15.7 mg of the solid catalyst component obtained in Example 3(2), thereby obtaining 92 g of an ethylene-1-butene powdery copolymer excellent in its particle property.

A yield of the copolymer per one g of the solid catalyst component was 5,870 g-copolymer/g-solid catalyst component (polymerization activity). The copolymer was found to have a short-chain branch number (SCB) of 13.8; 3.6% by weight of soluble parts in xylene (CXS), the total weight of the copolymer being 100% by weight; a bulk density of 0.361 g/ml; a melt flow rate (MFR) of 0.48; a melt flow rate ratio (MFRR) of 22.3; and a falling amount of 429 ml/sec.

Results are shown in Table 1.

### Example 4

### (1) Preparation of Solid Catalyst Component Precursor for Olefin Polymerization

Example 1(1) was repeated except that (i) the amount of hexane (94 ml) was changed to 21.4 ml, (ii) the inner temperature of the flask (10° C.) was changed to 20° C., and (iii) the amount of toluene (160 ml) added to the solid catalyst component precursor was changed to 180 ml, wherein the total amount of magnesium atoms contained in the organomagnesium compound used was 20 mol per one liter of the solvent, thereby obtaining a toluene slurry of the solid catalyst component precursor having an excellent particle shape, which slurry was found to have a concentration of 0.22 g-precursor/ml-slurry.

The solid catalyst component precursor was found to contain 1.99% by weight of titanium atoms, 38.3% by weight of ethoxy groups, and 3.57% by weight of butoxy groups.

### (2) Preparation of Solid Catalyst Component for Olefin Polymerization

Example 1(2) was repeated except that (i) the slurry was changed to the slurry obtained in Example 4(1), which was added to the flask in an amount such that 7.00 g of the solid catalyst component precursor was added thereto, and (ii) 2.2 ml of toluene was added, thereby obtaining a solid catalyst component having an excellent particle shape.

The solid catalyst component was found to contain 0.99% by weight of titanium atoms, and was found to have a median particle diameter of 39 μm.

### (3) Preparation of Ethylene-1-Butene Copolymer

Example 1(3) was repeated except that 17.6 mg of the solid catalyst component was changed to 11.0 mg of the solid catalyst component obtained in Example 4(2), thereby obtaining 79 g of an ethylene-1-butene powdery copolymer excellent in its particle property.

A yield of the copolymer per one g of the solid catalyst component was 7,460 g-copolymer/g-solid catalyst component (polymerization activity). The copolymer was found to have a short-chain branch number (SCB) of 13.3; 3.5% by weight of soluble parts in xylene (CXS), the total weight of the copolymer being 100% by weight; a bulk density of 0.387 g/ml; a melt flow rate (MFR) of 0.44; a melt flow rate ratio (MFRR) of 23.3; and a falling amount of 381 ml/sec.

Results are shown in Table 1.

### Example 5

### (1) Preparation of Solid Catalyst Component Precursor for Olefin Polymerization

Example 1(1) was repeated except that (i) the amount of hexane (94 ml) was changed to 8.6 ml, (ii) the inner temperature of the flask (10° C.) was changed to 20° C., and (iii) the amount of toluene (160 ml) added to the solid catalyst component precursor was changed to 180 ml, wherein the total amount of magnesium atoms contained in the organomagnesium compound used was 50 mol per one liter of the solvent, thereby obtaining a toluene slurry of the solid catalyst component precursor having an excellent particle shape, which slurry was found to have a concentration of 0.18 g-precursor/ml-slurry.

The solid catalyst component precursor was found to contain 1.59% by weight of titanium atoms, 38.6% by weight of ethoxy groups, and 3.84% by weight of butoxy groups.

### (2) Preparation of Solid Catalyst Component for Olefin Polymerization

Example 1(2) was repeated except that (i) the slurry was changed to the slurry obtained in Example 5(1), which was added to the flask in an amount such that 7.00 g of the solid catalyst component precursor was added thereto, and (ii) 0.9 ml of toluene was added, thereby obtaining a solid catalyst component having an excellent particle shape.

The solid catalyst component was found to contain 0.67% by weight of titanium atoms, and was found to have a median particle diameter of 46

### (3) Preparation of Ethylene-1-Butene Copolymer

Example 1(3) was repeated except that 17.6 mg of the solid catalyst component was changed to 14.0 mg of the solid catalyst component obtained in Example 5(2), thereby obtaining 102 g of an ethylene-1-butene powdery copolymer excellent in its particle property.

A yield of the copolymer per one g of the solid catalyst component was 7,290 g-copolymer/g-solid catalyst component (polymerization activity). The copolymer was found to have a short-chain branch number (SCB) of 13.3; 3.7% by weight of soluble parts in xylene (CXS), the total weight of the copolymer being 100% by weight; a bulk density of 0.346 g/ml; a melt flow rate (MFR) of 0.39; a melt flow rate ratio (MFRR) of 23.4; and a falling amount of 348 ml/sec.

Results are shown in Table 1.

### Comparative Example 1

### (1) Preparation of Solid Catalyst Component Precursor for Olefin Polymerization

Example 1(1) was repeated except that the amount of hexane (94 ml) was changed to 188 ml, wherein the total amount of magnesium atoms contained in the organomagnesium compound used was 2.3 mol per one liter of the solvent, thereby obtaining a toluene slurry of the solid catalyst component precursor having an inferior particle shape, which slurry was found to have a concentration of 0.21 g-precursor/ml-slurry.

The solid catalyst component precursor was found to contain 1.96% by weight of titanium atoms, 44.0% by weight of ethoxy groups, and 4.13% by weight of butoxy groups.

### (2) Preparation of Solid Catalyst Component for Olefin Polymerization

Example 1(2) was repeated except that (i) the slurry was changed to the slurry obtained in Comparative Example 1(1), which was added to the flask in an amount such that 7.00 g of the solid catalyst component precursor was added thereto, and (ii) the added amount of toluene (1.6 ml) was changed to 6.6 ml, thereby obtaining 7.00 g of a solid catalyst component having an inferior particle shape.

The solid catalyst component was found to contain 0.86% by weight of titanium atoms, and was found to have a median particle diameter of 50 μm.

### (3) Preparation of Ethylene-1-Butene Copolymer

Example 1(3) was repeated except that 17.6 mg of the solid catalyst component was changed to 16.7 mg of the solid catalyst component obtained in Comparative Example 1(2), thereby obtaining 148 g of an ethylene-1-butene powdery copolymer.

A yield of the copolymer per one g of the solid catalyst component was 8,850 g-copolymer/g-solid catalyst component (polymerization activity). The copolymer was found to have a short-chain branch number (SCB) of 16.1; 4.5% by weight of soluble parts in xylene (CXS), the total weight of the copolymer being 100% by weight; a bulk density of 0.321 g/ml; a melt flow rate (MFR) of 0.27; a melt flow rate ratio (MFRR) of 29.9; and a falling amount of 321 ml/sec.

Results are shown in Table 1.

### Comparative Example 2

### (1) Preparation of Solid Catalyst Component Precursor for Olefin Polymerization

Example 1(1) was repeated except that (i) the amount of hexane (94 ml) was changed to 4.3 ml, and (ii) the inner temperature of the flask (10° C.) was changed to 20° C., wherein the total amount of magnesium atoms contained in the organomagnesium compound used was 100 mol per one liter of the solvent, thereby obtaining a toluene slurry of the solid catalyst component precursor having a large amount of fines.

The solid catalyst component precursor was found to contain 1.66% by weight of titanium atoms, 38.6% by weight of ethoxy groups, and 3.99% by weight of butoxy groups.

Results are shown in Table 1.

### Example 6

### (1) Preparation of Solid Catalyst Component for Olefin Polymerization

### Activation Step 1:

A 100 ml flask equipped with an agitator, a dropping funnel and a thermometer was purged with a nitrogen gas. The toluene slurry obtained in Example 2(1) was added to the flask in an amount such that 8.00 g of the solid catalyst component precursor was added thereto. Then, a supernatant liquid of the slurry was extracted until the total volume of the slurry reached 26.5 ml. A mixture of 16.0 ml (146 mmol) of titanium tetrachloride with 0.8 ml (4.7 mmol) of dibutyl ether was added to the flask at 40° C. Further, a mixture of 1.6 ml (1.7 mmol) of phthaloyl chloride with 1.6 ml of toluene was added dropwise to the flask over five minutes. After completion of the dropwise addition, the resultant mixture was agitated at 115° C. for 3 hours. The reaction mixture was solid-liquid separated at 115° C., and the separated solid was washed at 115° C. with each 40 ml of toluene three times, thereby obtaining a washed solid.

### Activation Step 2:

Toluene was added to the above washed solid to obtain 26.5 ml of a toluene slurry of the solid. A mixture of 0.8 ml (4.7 mmol) of dibutyl ether, 0.45 ml (1.7 mmol) of diisobutyl phthalate, and 6.4 ml (58 mmol) of titanium tetrachloride was added to the toluene slurry, and the resultant mixture was agitated at 105° C. for one hour. The obtained reaction mixture was solid-liquid separated at 105° C., and the separated solid was washed at 105° C. with each 40 ml of toluene two times, thereby obtaining a washed solid.

### Activation Step 3:

Toluene was added to the above washed solid to obtain 26.5 ml of a toluene slurry of the solid, and the resultant mixture was heated up to 105° C. A mixture of 0.8 ml (4.7 mmol) of dibutyl ether and 6.4 ml (58 mmol) of titanium tetrachloride was added to the mixture. The mixture was agitated at 105° C. for one hour. The obtained reaction mixture was solid-liquid separated at 105° C., and the separated solid was washed at 105° C. with each 40 ml of toluene two times, thereby obtaining a washed solid.

### Activation Step 4:

Toluene was added to the above washed solid to obtain 26.5 ml of a toluene slurry of the solid, and the resultant mixture was heated up to 105° C. A mixture of 0.8 ml (4.7 mmol) of dibutyl ether and 6.4 ml (58 mmol) of titanium tetrachloride was added to the mixture. The mixture was agitated at 105° C. for one hour. The obtained reaction mixture was solid-liquid separated at 105° C., and the separated solid was washed at 105° C. with each 40 ml of toluene three times, and was further washed at room temperature with each 40 ml of hexane three times. The washed solid was dried under reduced pressure, thereby obtaining 7.24 g of a solid catalyst component having an excellent particle shape.

The solid catalyst component was found to contain 1.9% by weight of titanium atoms, 11.4% by weight of diethyl phthalate, 1.6% by weight of ethyl n-butyl phthalate, and 3.7% by weight of diisobutyl phthalate, the total weight of the solid catalyst component being 100% by weight.

### (2) Polymerization of Propylene

A 3 liter-inner volume stainless-steel autoclave was made vacuum. There was added thereto 0.033 MPa of hydrogen, and were also added thereto 2.6 mmol of triethylaluminum (organoaluminum compound), 0.26 mmol of cyclohexylethyldimethoxysilane (external electron donor), and 6.34 mg of the solid catalyst component obtained in Example 6(1), and was further added thereto 780 g of liquid propylene. The autoclave was heated up to 80° C., thereby initiating propylene polymerization. The polymerization was carried out at 80° C. for one hour, thereby obtaining 290 g of a powdery propylene homopolymer having an excellent particle property.

A yield of the propylene homopolymer per one g of the solid catalyst component was 45,700 g-homopolymer/g-solid catalyst component (polymerization activity). The homopolymer was found to have 0.54% by weight of soluble parts in xylene (CXS), the total weight of the homopolymer being 100% by weight; an intrinsic viscosity ([η]) of 2.15 dl/g; a bulk density of 0.468 g/ml; and a falling amount of 421 ml/sec.

Results are shown in Table 1.

The above content (% by weight) of respective phthalates was measured according to a method comprising the steps of:

(1) dissolving about 30 mg of a sample in 100 ml of N,N-dimethylacetamide to obtain a solution, and

(2) measuring a content of respective phthalates contained in the solution, according to a gas chromatography internal standard method.

The above intrinsic viscosity (dl/g) was measured at 135° C. using TETRALINE (tetrahydronaphthalene) as a solvent.

### Example 7

### (1) Preparation of Solid Catalyst Component for Olefin Polymerization

Example 6(1) was repeated except that the “toluene slurry obtained in Example 2(1)” (Activation step 1) was changed to the “toluene slurry obtained in Example 3(1)”, thereby obtaining 7.37 g of a solid catalyst component having an excellent particle shape.

The solid catalyst component was found to contain 2.0% by weight of titanium atoms, 9.7% by weight of diethyl phthalate, 1.2% by weight of ethyl n-butyl phthalate, and 3.1% by weight of diisobutyl phthalate, the total weight of the solid catalyst component being 100% by weight.

### (2) Polymerization of Propylene

Example 6(2) was repeated except that 6.34 mg of the solid catalyst component was changed to 9.26 mg of the solid catalyst component obtained in Example 7(1), thereby obtaining 330 g of a powdery propylene homopolymer having an excellent particle property.

A yield of the propylene homopolymer per one g of the solid catalyst component was 35,600 g-homopolymer/g-solid catalyst component (polymerization activity). The homopolymer was found to have 0.51% by weight of soluble parts in xylene (CXS), the total weight of the homopolymer being 100% by weight; an intrinsic viscosity ([η]) of 2.19 dl/g; a bulk density of 0.474 g/ml; and a falling amount of 420 ml/sec.

Results are shown in Table 1.

### Comparative Example 3

### (1) Preparation of Solid Catalyst Component Precursor for Olefin Polymerization

A 500 ml-inner volume separable flask equipped with an agitator was purged with a nitrogen gas. There were put in the flask 270 ml of hexane, 8.1 ml (23 mmol) of tetra-n-butoxytitanium (titanium compound), and 79.9 ml (357 mmol) of tetraethoxysilane (silicon compound). While agitating the resultant mixture, and keeping an inner temperature of the flask at 20° C., 166 ml (382 mmol) of a di-n-butyl ether solution (concentration: 2.3 mol/liter) of n-butylmagnesium chloride (organomagnesium compound) was added dropwise to the mixture over 3 hours at a constant dropping rate. The total amount of magnesium atoms contained in the organomagnesium compound used was 1.4 mol per one liter of the solvent. After completion of the dropwise addition, the obtained mixture was agitated to 20° C. for one hour. Then, the reaction mixture was filtered, and the obtained solid was washed with each 220 ml of toluene three times, thereby obtaining a solid catalyst component precursor having an excellent particle shape. There was added 220 ml of toluene to the solid catalyst component precursor, thereby obtaining a toluene slurry of the solid catalyst component precursor, which slurry was found to have a concentration of 0.16 g-precursor/ml-slurry.

The above solid catalyst component precursor was found to contain 2.16% by weight of titanium atoms, 40.9% by weight of ethoxy groups, and 4.52% by weight of butoxy groups.

### (2) Preparation of Solid Catalyst Component for Olefin Polymerization

Example 6(1) was repeated except that the “toluene slurry obtained in Example 2(1)” (Activation step 1) was changed to the “toluene slurry obtained in Comparative Example 3(1)”, thereby obtaining 6.83 g of a solid catalyst component having an inferior particle shape.

The solid catalyst component was found to contain 2.0% by weight of titanium atoms, 9.3% by weight of diethyl phthalate, 1.1% by weight of ethyl n-butyl phthalate, and 3.2% by weight of diisobutyl phthalate, the total weight of the solid catalyst component being 100% by weight.

### (3) Polymerization of Propylene

Example 4(2) was repeated except that 6.34 mg of the solid catalyst component was changed to 6.34 mg of the solid catalyst component obtained in Comparative Example 2(2), thereby obtaining a powdery propylene homopolymer.

A yield of the propylene homopolymer per one g of the solid catalyst component was 53,000 g-homopolymer/g-solid catalyst component (polymerization activity). The homopolymer was found to have a bulk density of 0.463 g/ml, and a falling amount of 406 ml/sec.

Results are shown in Table 1.

TABLE 1

| | Example | | | | | | | Comparative Example | | |
|---|---|---|---|---|---|---|---|---|---|---|
| | 1 | 2 | 3 | 4 | 5 | 6 | 7 | 1 | 2 | 3 |
| n-Buthylmagnesium | 428 | 428 | 428 | 428 | 428 | 428 | 428 | 428 | 428 | 382 |
| chloride (mmol) | | | | | | | | | | |
| Hexane (ml) | 94 | 70 | 47 | 21.4 | 8.6 | 70 | 47 | 188 | 4.3 | 270 |
| Mg concentration | 4.6 | 6.1 | 9.1 | 20 | 50 | 6.1 | 9.1 | 2.3 | 100 | 1.4 |
| (mol-Mg/L-solvent) | | | | | | | | | | |
| Polymer (Note) | EB | EB | EB | EB | EB | PP | PP | EB | — | PP |
| Bulk density (g/ml) | 0.355 | 0.372 | 0.361 | 0.387 | 0.346 | 0.468 | 0.474 | 0.321 | | 0.463 |
| Falling amount (ml/sec) | 392 | 419 | 429 | 381 | 348 | 421 | 420 | 321 | | 406 |

Note:
EB and PP mean an ethylene-1-butene copolymer and a propylene homopolymer, respectively.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A process for producing a solid catalyst component precursor for olefin polymerization, comprising the step of adding an organomagnesium compound to a solution containing a Si—O bond-containing silicon compound, a titanium compound represented by following formula [I], and a solvent, in an amount of 2.5 to 90 mol, per one liter of the solvent, of magnesium atoms contained in the organomagnesium compound added: 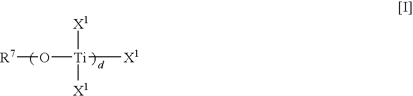
wherein R⁷ is a hydrocarbyl group having 1 to 20 carbon atoms; X¹ is independently of one another a halogen atom or a hydrocarbyloxy group having 1 to 20 carbon atoms; and d is a number of 1 to 20.

2. The process according to claim 1, wherein the solvent is a hydrocarbon.

3. The process according to claim 1, wherein the solvent is an aliphatic hydrocarbon.

4. A process for producing an olefin polymerization solid catalyst component, comprising the step of contacting a solid catalyst component precursor for olefin polymerization produced according to the process of claim 1 with a halogenating metal compound represented by the following formula, an internal electron donor, and an optional organic acid halide:
M(R¹¹)ₑX³ₘ₋ₑ
wherein M is an element of Group 4, 13 or 14; R¹¹ is an alkyl or alkoxy group having 2 to 18 carbon atoms, or an aryl or aryloxy group having 6 to 18 carbon atoms; X³ is a halogen atom; m is an atomic valence of M; and e is a number satisfying 0<b≦m.

5. A process for producing an olefin polymerization solid catalyst, comprising the step of contacting an olefin polymerization solid catalyst component produced according to the process of claim 4 with an organoaluminum compound, and an optional external electron donor.

6. A process for producing an olefin polymer, comprising the step of polymerizing an olefin in the presence of an olefin polymerization solid catalyst produced according to the process of claim 5.
